(19) United States
(12) Patent Application Publication
(10) Pub. No.: US 2025/0256661 A1
(43) Pub. Date: Aug. 14, 2025

(54) Support for an Electronic Device

(71) Applicant: Andreas Alberto Hansel Diaz, Clarksville, MD (US)

(72) Inventor: Andreas Alberto Hansel Diaz, Clarksville, MD (US)

(21) Appl. No.: 18/438,458

(22) Filed: Feb. 10, 2024

(51) Int. Cl. B60R 11/02; B60R 11/00; B60R 16/03

(52) U.S. Cl. CPC B60R 11/0241; B60R 16/03; B60R 2011/0007; B60R 2011/0075

(57) ABSTRACT

A holder for an electronic device. The holder including a base member, an extension member extending from the base member and a connection member supported by the extension member. The connection member including a connection mechanism for securing an electronic device thereto. The holder is anchored to an environment and secures the electronic device in the environment so that a user may easily and conveniently view a display of the electronic device in a hands-free manner.

### FIELD

This specification relates to supports for supporting and positioning hand-held electronic devices so that a display screen of the device is properly oriented and within view of a user.

### BACKGROUND

Hand-held electronic devices such as cell phones and tablets are very commonly owned today. Sometimes a user may want to view the device's display while the device is being held by a support device or holder mounted to the nearby environment (e.g., mounted on a vehicle dashboard, a kitchen surface, etc.). For example, a driver of a vehicle whose hands are otherwise occupied may want to occasionally glance at a cellular phone when the vehicle is stopped in order to review directions on the cellular phone screen.

As a device may also be supported by such a holder for an extended period of time, the holder may include a charging device where the charging device may be wireless or pluggable into the phone charge port. If the holder is mounted in/to a vehicle, power (e.g., from a charge port in the vehicle) may be supplied (e.g., via a charging cord) to the phone while it is supported by the holder.

It would be beneficial to have an electronic device support or holder capable of supporting an electronic device in a convenient viewing position in an environment and include a charging cable concealed within the holder for charging the electronic device while being held.

### BRIEF DESCRIPTION OF THE INVENTION

The present invention includes a base member. The base member may be connected to an environment structure such as a kitchen counter, an interior of an automobile, or to any other environment where a user may want to (hands-free) view a screen of an electronic device. The device may further include an extension member connected to the base member. At least a portion of the extension member may extend away from the base member. A connector is connected to the extension member so that the connector is engageable with the electronic device to secure the electronic device in a convenient viewable position. An electronic device charger is supported by the connector. A charging cable extends between a power outlet in the environment structure and the electronic device charger to supply power to the electronic charging device while the device is supported by the holder and viewable by the user.

### BRIEF DESCRIPTION OF THE DRAWINGS

Embodiments will now be described by way of non-limiting example with reference to the accompanying drawings in which:

FIG. 1 is a top front perspective view of the holder of the present invention.

FIG. 2 is rear view of the holder of FIG. 1.

FIG. 3 is bottom perspective view of the holder of FIG. 1.

FIG. 4 is a side view of the holder of FIG. 1.

FIG. 5 is a front perspective view of the holder of FIG. 1 in an automobile interior environment.

### DETAILED DESCRIPTION

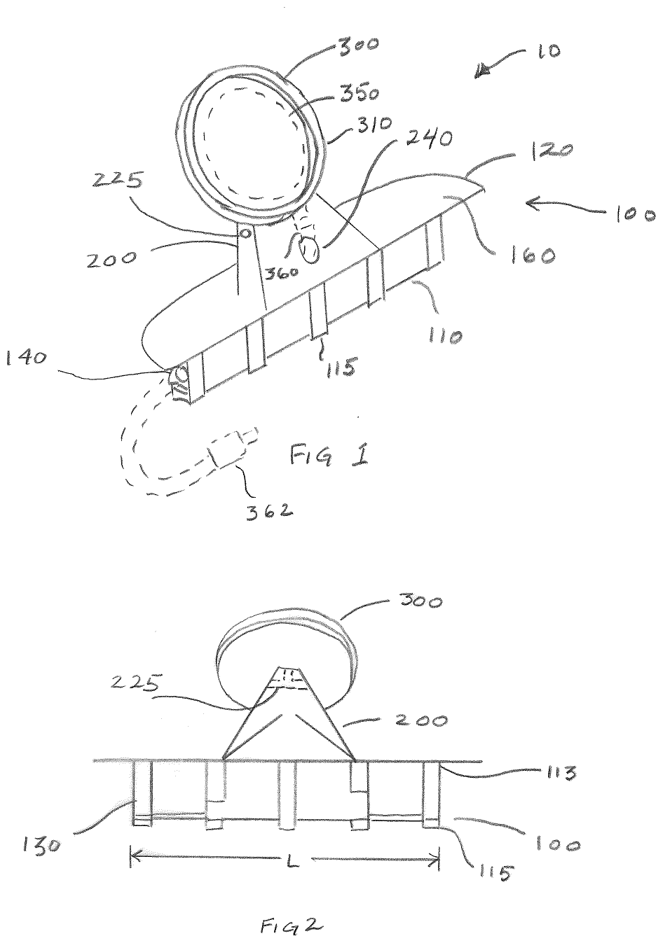

As shown in FIGS. 1-4, disclosed herein is a holder or support 10 for positioning an electronic device to be viewed by a user while being charged. The device includes a base member 100. Base member 100 includes an insertion portion 110 and a flange portion 120. Insertion portion 110 may be elongated such that its nominal length L is at least three times its nominal width W. Insertion portion 110 may further include an upper flange end 113 and a lower insertion end 115. Insertion portion 110 may taper down in width from upper flange end 113 toward to lower insertion end 115 which is a terminal end. Insertion portion 110 may also include ribs 130 that extend longitudinally in the direction of taper and are laterally spaced and located periodically along its length L. Ribs 130 may strengthen a sidewall of insertion portion 110 and tapering of insertion portion 110 may allow insertion end 115 to be more easily inserted into a receiving portion (e.g., receptacle 405) in the environment (e.g., in a automobile interior). Insertion portion 110 may also include an opening and passage 140 through which an electrical cable 360 may passed. Flange portion 120 extends laterally outward from insertion portion 110 so that when base portion 100 is inserted into an opening for securement, an upper surface portion 160 of flange portion 120 covers the interface between securement receptacle 405 and insertion portion 110. The securement opening into which insertion portion 110 is inserted may be in any number of use environments including a vehicle, a kitchen, an office, etc.

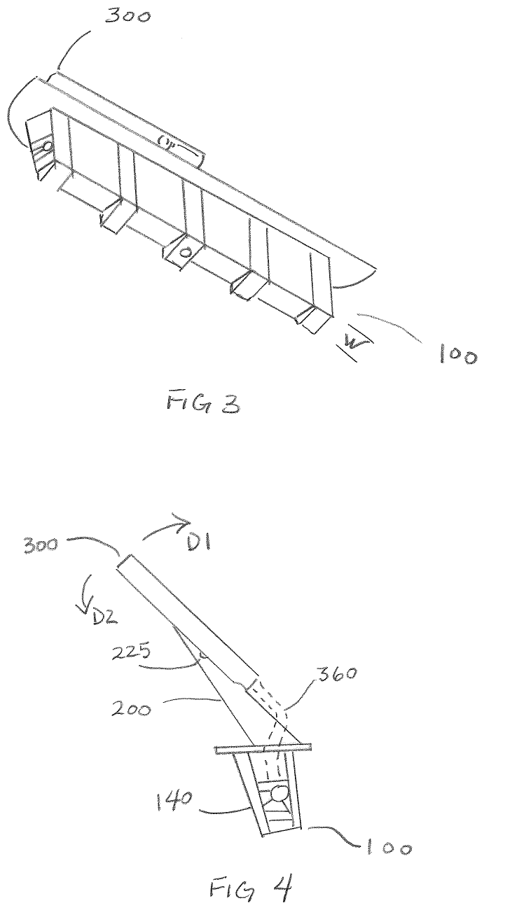

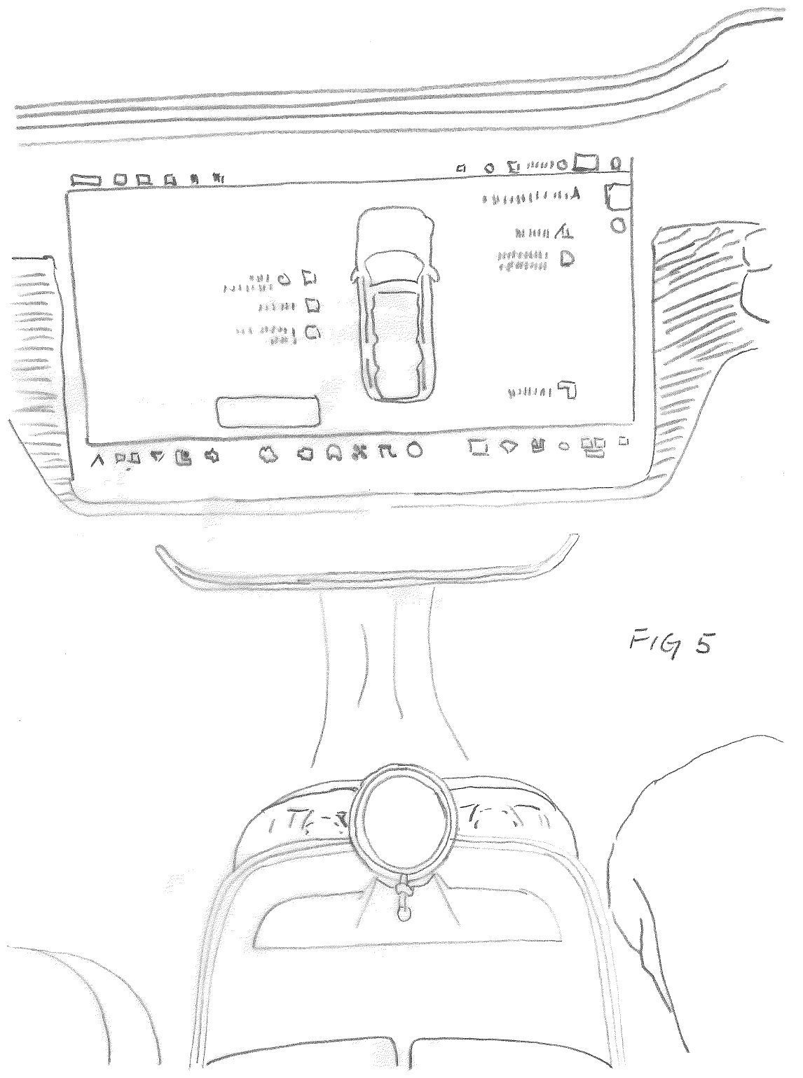

Holder 10 further includes an extension member 200 which is connected to insertion portion 110 and extends away from flange portion 120 of insertion portion 110. Extension portion 200 may also include an opening or passage through which an electrical cable 360 may be passed. Holder 10 may also include a connector member 300. Connector member 300 may be (but need not be) round or disk shaped and form a recess (e.g., disk shaped) for receiving a correspondingly shaped electronic member 350. A wall 310 of connection member 300 may be interrupted at a lower part of connection member 300 to allow for passage of electrical cable 360 therethrough. Extension portion 200 may taper down from flange portion 120 toward connector member 300. A pin 225 may pass through a portion of extension member 200 and a portion of connector member 300. Pin 225 may allow connection member 300 to pivot relative to extension member 200 in directions D1 and D2 shown in FIG. 4.

The shaped electronic member 350 may be an electric device charger and may be a wireless charger. The charger 350 may a also include a magnet for attracting and securing the electronic device to be charged thereto. As mentioned previously, an electrical cable 360 extends between charger 350 and a power supply port in the environment (e.g., a automobile interior). Electrical cable 360 may extend from a lower portion of charger 350 through a passage in wall 310 of connector member 300, through opening or passage 240 in extension member 200 and through opening 140 in insertion member 110. An end of cable 360 may be terminated with an electronic connector 362 (e.g., a USBC connector). Connector 360 may be routed through the vehicle (e.g., through the automobile center console 400) to a power receptacle located there in (e.g., USBC, USB, etc.).

FIG. 5 shows a view of an automobile interior from the rear of a vehicle. A center console 400 includes a rest surface 430 for resting objects thereon. Rest surface 430 may also include a wireless charger thereunder for charging electronic devices (e.g., cell phones, watches, etc) placed flat on surface 430. Rest surface 430 may also include an opening or receptacle 405 where other small items may be stored. Alternatively, receptacle 405 may serve as a receptacle for receiving insertion portion 110 of holder 10. Receptacle 405 includes an inner opening that comes into contact with ribs 130 of insertion portion 110 so that holder 10 fits snuggly in receptacle 405 when insertion portion 110 is fully inserted into receptacle 405. Furthermore, as mentioned above, flange portion 120 covers receptacle 405 to conceal the interconnection. With cable 360 now extending from opening 140, cable 360 can be routed through the center console to a power supply port (e.g., hidden in a center console storage compartment). Center console 400 may also include cushioned flip-up compartment doors 422 leading to a storage compartment thereunder (not shown). One or more cup holders 410 may be included for holding at least one cup 420. A front dashboard display 450 may also be mounted in the vehicle interior.

1. A holder for an electronic device comprising:
a base member, the base member connectable to an environment structure, an extension member connected to the base member, at least a portion of the extension member extending away from the base member, a connector connected to the extension member, the connector engageable with the electronic device to secure the electronic device in a convenient viewable position, an electronic device charger, the electronic device charger supported by the connector, a charging cable, the charging cable extending between a power outlet in the environment structure and the electronic device charger to supply power to the electronic device charging device.

2. The holder of claim 1, wherein the electronic device charger is a wireless charger.

3. The holder of claim 1, further including a passage through at least one of the base and extension member within which the charging cable passes.

4. The holder of claim 1, wherein the connection member is pivotable relative to the extension member to secure an electronic device at various viewing angles.

5. The holder of claim 1, wherein the base further includes a tapered insertion portion.

6. The holder of claim 5, wherein the insertion portion includes a plurality of downwardly extending ribs.

7. The holder of claim 1, further including an electrical cable passing through the base member.

8. In combination, a vehicle center console and a holder for an electronic device comprising:
a center console of a vehicle including a receptacle,
a holder including a base member, the base member connectable to the center console, an extension member connected to the base member, at least a portion of the extension member extending away from the base member, a connector connected to the extension member, the connector engageable with the electronic device to secure the electronic device in a convenient viewable position, an electronic device charger, the electronic device charger supported by the connector, a charging cable, the charging cable extending between a power outlet in the environment structure and the electronic device charger to supply power to the electronic device charging device.

9. The combination of claim 8 wherein, the receptacle is an elongate receptacle.

10. The combination of claim 8, wherein the receptacle defines a closed pocket with inward facing walls and an opening at a top thereof capable of holding items placed in the opening for a user's convenience.

11. The combination of claim 8, wherein a length of the receptacle is at least three times a width of the receptacle.

12. The combination of claim 8, wherein the center console further includes a cupholder, the cupholder disposed forward and/or lower than the receptacle so as not to interfere with a cup being placed in the cupholder.

13. The combination of claim 8, wherein the center console further includes a rest surface for resting objects thereon.

14. The combination of claim 13, wherein a wireless charger is disposed under the rest surface so that electronic devices placed on the rest surface may charge wirelessly.

15. The combination of claim 10, wherein the opening is in the same plane as the rest surface.

16. The combination of claim 8, wherein the holder further includes an insertion member and the insertion member is received in the receptacle.

17. The combination of claim 15, wherein the holder further includes an flange member that extends laterally from an end of the insertion member, the flange member limiting the extent of insertion of the insertion member and overlapping the receptacle.

18. The combination of claim 8, wherein the connector is pivotable relative to the extension member.

19. The combination of claim 9, wherein the charging cable passes through at least one passage in the holder and through the center console to a power supply receptacle.

20. In combination, a vehicle center console and a holder for an electronic device comprising:
a center console of a vehicle including a receptacle,
a holder including a base member, the base member connectable to the center console, an extension member connected to the base member, at least a portion of the extension member extending away from the base member, a connector connected to the extension member, the connector engageable with the electronic device to secure the electronic device in a convenient viewable position, an electronic device charger, the electronic device charger supported by the connector, a charging cable, the charging cable extending between a power outlet in the environment structure and the electronic device charger to supply power to the electronic device charging device, wherein the receptacle is an elongate receptacle, the receptacle defining a closed pocket with inward facing walls and an opening at a top thereof capable of holding items placed in the opening for a user's convenience, wherein a length of the receptacle is at least three times a width of the receptacle.
